(19) United States
(12) Patent Application Publication
(10) Pub. No.: US 2006/0166661 A1
(43) Pub. Date: Jul. 27, 2006

(54) Wireless communication device having a telephone number-limited back calling function

(75) Inventor: Ya-Fen Lin, Taipei (TW)

Correspondence Address: BRUCE H. TROXELL, SUITE 1404, 5205 LEESBURG PIKE, FALLS CHUCH, VA, 22041, US

(73) Assignee: Inventec Appliances Corp.

(21) Appl. No.: 11/041,965

(22) Filed: Jan. 26, 2005

(51) Int. Cl. H04M 3/00

(52) U.S. Cl. 455/418

(57) ABSTRACT

A wireless communication device having a number-limited back calling function is disclosed, comprising a receiving module receiving a telephone number corresponding to an in-coming call, a memory storing at least a limited telephone number, a comparison module comparing if the telephone number of the in-coming call is the same as the limited telephone number stored in the memory, a limiting module limiting a back call from being sent to a communication device corresponding to the in-coming call with the limited telephone number if the comparison result is true, and a back calling interface calling back to the telephone number corresponding to the in-coming call if the comparison result is different.

### BACKGROUND OF THE INVENTION

(1) Field of the Invention

The present invention relates to a wireless communication device, and particularly to a wireless communication device having a telephone number-limited back calling function.

(2) Description of the Prior Art

Wireless communication devices have become more and more prevailing and indispensable for human living. In spite of this, these devices have their drawbacks of inconveniences, such as poor signal reception owing to the site of a base station or a geographical shielding and expensive communication fee significantly limiting some desirable out-callings.

FIG. 1 is a schematic illustration of an operation of limiting an out sending-call in a prior communication device. For saving the communication fee, the prior communication device 1 often has a limiting function on out-calls therefrom. The out calling limiting function is set through a second personal identification number (PIN2) code provided by the communication service provider which the communication device is serviced with. For example, the wireless communication device 1 may set a function of out-sending calling allowance only for a receiving end with a telephone number included in a set of pre-set telephone numbers recorded in a memory in the telecommunication service provider through a Subscriber Identity Module (SIM) 7 and by storing the set of pre-set telephone numbers. When the wireless communication device 1 is made to send out a call to a target device 11 having a target telephone number, the SIM 7 determines if the communication device 1 has a telephone number-limiting function before the device 1 sends out the target telephone number through a dialing interface 3 and the corresponding in-coming call signal through a communication interface 4. If not, the communication device 1 sends out the in-coming call signal corresponding to the target telephone number through the communication interface 4 to the communication device 11 having the target telephone number.

If the communication device 1 has a telephone number-limiting function, a comparison module 5 in the telecommunication service provider 9 compares if the telephone number which the communication device 1 sends out is the same as one of the set of telephone numbers pre-stored in the telecommunication service provider 9. If yes, the in-coming call signal from the communication device 9 is directed to another communication device 11 having the target telephone number. Otherwise, a limiting module 6 in the telecommunication service provider 9 bans the out-sending call from being transmitted to the intended communication device 11.

Such an out-sending call limiting function has been widely applied where a company equips some employees with wireless communication devices 1, in particular those employees having to frequently go out on duty. To avoid a private out-sending call not related to the duty made by the employees and thus high expenditure, the company may specify some telephone numbers with respect to the communication device 1 to the employees and the employees may only make out-sending calls with the specified telephone numbers.

Although the prior technology of limiting private out-sending calls may be used, a back calling function is provided in the current wireless communication device 1, the back-calling function permits a back call in response to an in-coming call with its telephone number displayed no matter if any calling limitation is made on the device 1. That is, the communication device 11, particularly the device with its telephone number having a fore part of 0209, 0204, 0941 and 0951 in Taiwan, may be made to call back the communication device having previously called in as long as the telephone number of the latter device is displayed on the communication device 1. In this consideration, the company may not achieve its original purpose of limiting private out-sending calls from being made and saving expenditure on the communication fee.

Furthermore, the prior settings of specific functions through the PIN2 code have to be done through communication with the telecommunication service provider 9 which is proved to be a troublesome job. Also, the prior out-sending call limiting function may be set only with a set of telephone numbers but not with a single telephone number and may not be set with a set of telephone numbers consisting of similar telephone numbers, which seems not operation effective.

Therefore, there is a need to provide a wireless communication device with a function of limiting a back call from being sent out by setting a set of limited telephone numbers in the device.

### SUMMARY OF THE INVENTION

Therefore, it is an object to provide a wireless communication device having a function of limiting a back call from being sent out intentionally or unintentionally such as a high cost call and a prohibited call.

To achieve the object, the present invention provides a wireless communication device having a telephone number-limited back calling function to limit a back call to a telephone number corresponding to a previous in-coming call and displayed on a received calls list in the device, comprising a receiving module receiving a telephone number of an in-coming call, a memory storing at least a limited telephone number, a comparison module comparing if the telephone number corresponding to the in-coming call is the same as the limited telephone number, a limiting module limiting a back call from being sent to a communication device corresponding to the in-coming call with the limited telephone number if the comparison result is true, and a back calling interface calling back the communication device corresponding to the in-coming call without the limited telephone number.

With the wireless communication device having the telephone number-limited back calling function according to the present invention, the device may be exempted from sending out a prohibited or undesired back call intentionally or unintentionally and thus may achieve the purpose of saving expenditure on communication fee. The advantages and spirits may be best understood with reference to the following description and the attached drawings.

### BRIEF DESCRIPTION OF THE DRAWINGS

The present invention will now be specified with reference to its preferred embodiment illustrated in the drawings, in which

FIG. 1 is a schematic illustration of a telephone number-limited back calling function provided by in a prior wireless communication;

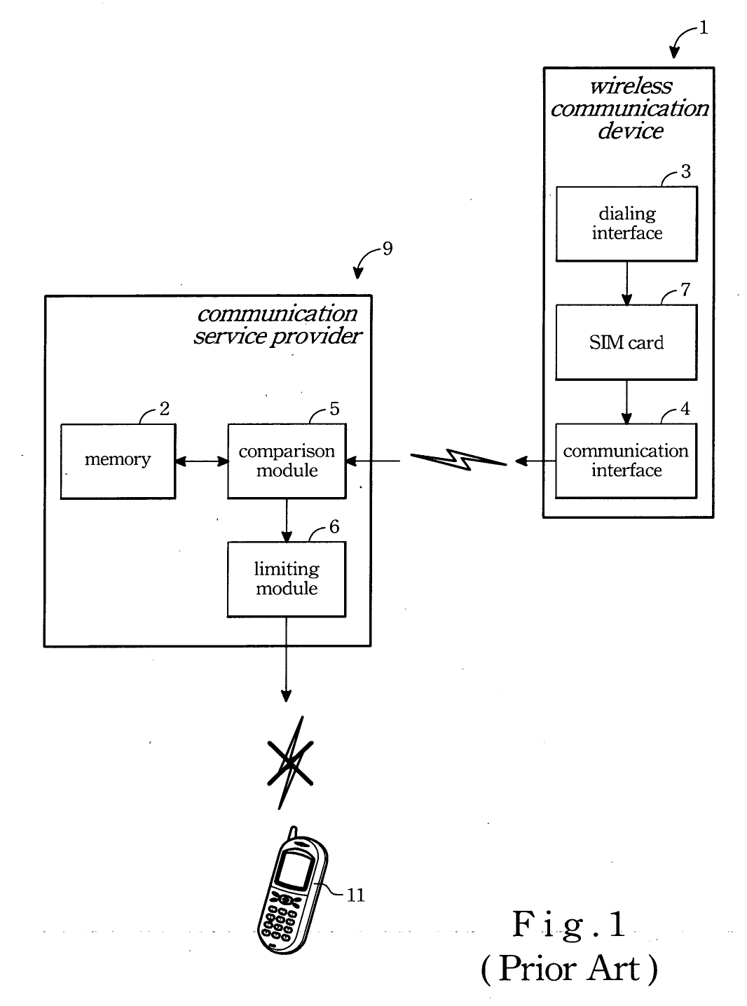

FIG. 2 is a schematic illustration of a wireless communication device having the number-limited back calling function according to the present invention; and

FIG. 3 is a flowchart describing a method of limiting a back call corresponding to a limited telephone number according to the present invention.

### DESCRIPTION OF THE PREFERRED EMBODIMENT

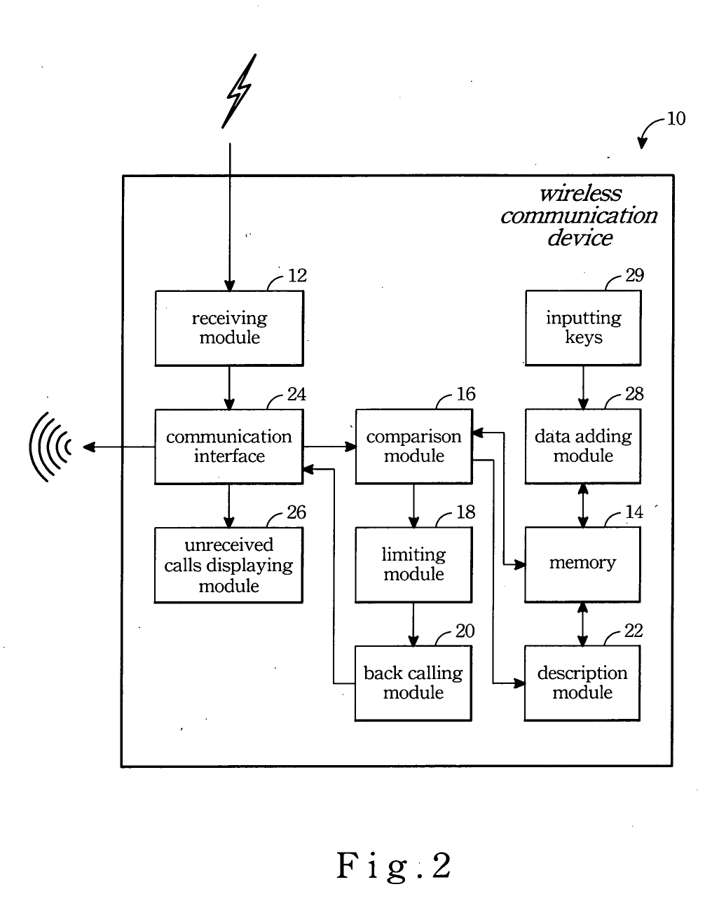

FIG. 2 is a schematic illustration of a wireless communication device 10 having a telephone number-limiting back calling function according to the present invention. As shown, the wireless communication device 10 comprises a receiving module 12, a memory 14, a comparison module 16, a limiting module 18, a back calling module 20, a description module 22, a communication interface 24, an unreceived calls displaying module 26, a data adding module 28 and an inputting key 29.

In the wireless communication device, the receiving module 12 is used to receive a telephone number corresponding to an in-coming call. The memory 14 is used to store at least one set of limited telephone numbers, such as those numbers with a fore part of 0209, 0204, 0941 and 0951 in Taiwan. The comparison module 16 is used to compare the telephone number corresponding to the in-coming call and the limited telephone numbers recorded in the memory 14. The comparison between the numbers as mentioned may be made over some digits-in-succession in the number, the whole digits in the number or the like. As an example of the former scheme, if a call having the telephone number 0204123456 is coming in and a fore-part number 0204 is stored in the set of limited telephone numbers recorded in the memory 14, the telephone number 0204123456 is determined to be the same as the pre-stored limited digits-in-succession in the memory 14.

The limiting module 18 is used to limit the device 10 to call back the communication device making the previous in-coming call, in the afro-mentioned case the device with the telephone number 0204123456, when the comparison result generated in the comparison module 16 is true, i.e. the telephone number or the fore part thereof corresponding to the in-coming call has been recorded in the set of limited telephone numbers in the memory 14. In the case that the comparison result is not true, the back calling module 20 is used to call back the communication device corresponding to the previous in-coming call. That is, the telephone number corresponding to the in-coming call is allowed or not limited to be called back by the wireless communication device 10. Further, the back calling module 20 may be enabled or disenabled by issuing a notification having information of choosing a limiting function or a non-limiting function to a user of the device 10 and obtaining a choice by the user in response to the notification before limiting or allowance of a back call is determined. In this case, the user may determine if the number-limiting function should be active or not.

The wireless communication device 10 may further comprises a description module 22 used to describe the reason why the telephone number is limited when the telephone number corresponding to the in-coming call is the same as one of the set of limited telephone number recorded in the memory 14. For example, when a telephone number with a fore-part number 0204 is banned from being called back, the description module 22 then gives a description, such as “A High Charged Call”, to the user as the reason of telephone number limiting.

The communication interface 24 is used to link to the communication device making the in-coming call for communication. The unreceived calls displaying module 26 is used to display the telephone number correspond to the in-coming call when the in-coming call is not received by the communication interface 24. Next, the unreceived and displayed telephone number may be compared by the comparison module 12 of the inventive device 10 as above mentioned.

The data adding module 20 is used to add to or delete from the set of limited telephone numbers recorded in the memory 14. Certainly, modifying a pre-set limited telephone number may also be performed through the data adding module 20. In doing this telephone number changing operation, the inputting key 29 may be used.

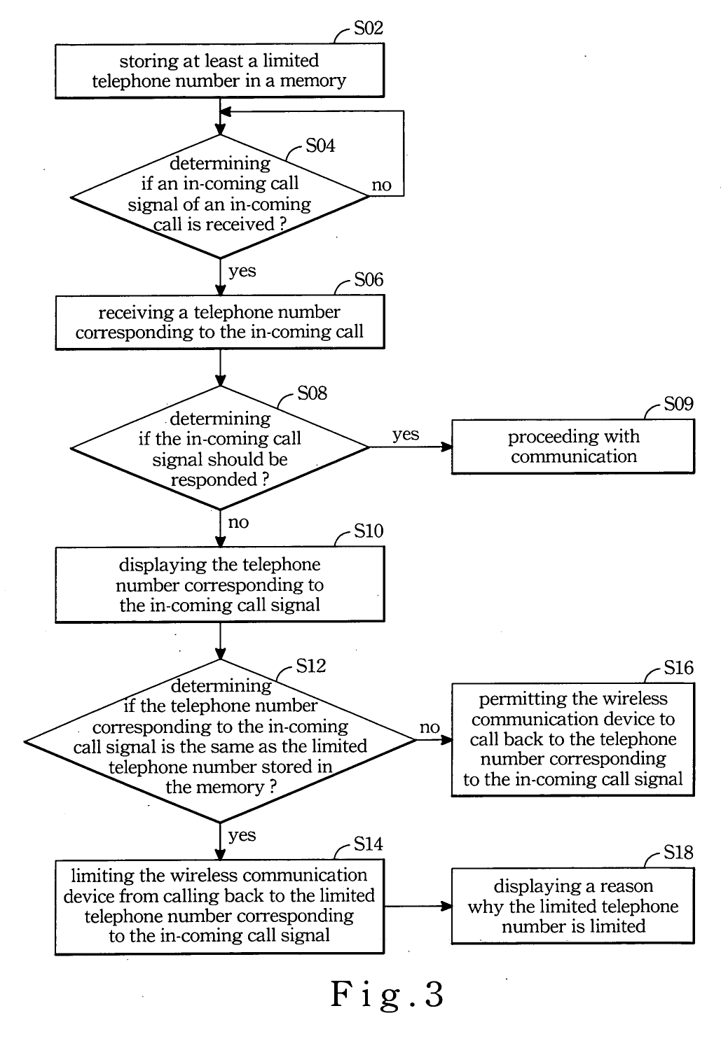

FIG. 3 illustrates a flowchart of a method of limiting a telephone number limited back call according to the present invention, which is implemented in the wireless communication device shown in FIG. 2. Referring to FIG. 3, the method of limiting a telephone number limited back call according to the present invention comprises the following steps. At first, storing at least a set of limited telephone number in the memory 14, such as a telephone number having a fore part of 0209, 0204, 0941 and 0951 (S02). Next, receiving an in-coming call signal of an in-coming call (S04). Then, receiving a telephone number corresponding to the in-coming call. Thereafter, determining if the in-coming call signal corresponding to the in-coming call should be responded. If yes, the in-coming call signal is responded (S06). If the in-coming call signal is not responded by the communication interface, displaying the telephone number corresponding to the in-coming call.

Next, comparing the received telephone number corresponding to the in-coming call and a set of limited telephone numbers recorded in the memory. If the comparison result shows the received telephone number has been previously recorded in the memory, limiting the wireless communication device to call back the telephone number corresponding to the in-coming call (S14). If the comparison result shows the different, allowing the wireless communication device to call back the telephone number corresponding to the in-coming call (S16). Further, a step of issuing a notification having information of choosing a limiting function or a non-limiting function to a user of the device 10 and obtaining a choice by the user in response to the notification before limiting or allowance of a back call is determined. In this case, the user may determine if the number-limiting function should be active or not. Optionally, a step of displaying and describing the reason why the telephone number received is limited to be called back may be added when the telephone number of the in-coming call is the same as one of the set of limited telephone numbers recorded in the memory. For example, when a telephone number with a fore-part number 0204 is banned from being called back, a description, such as “A High Charged Call”, is displayed to the user as the reason of number limiting.

In addition, the method of limiting a back call may further comprises a step of adding or deleting a limited telephone number to or from the set of limited telephone numbers recorded in the memory.

Accordingly, with the device and method of limiting a back call to a limited telephone number implemented, the purpose of limiting an out-sending call from being sent out intentionally or unintentionally such as a high cost call and a prohibited call.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A wireless communication device having a telephone number-limited back calling function to limit a back call to a telephone number corresponding to a previous in-coming call, comprising:
a receiving module receiving the telephone number corresponding to the in-coming call;
a memory storing at least a limited telephone number;
a comparison module comparing if the telephone number corresponding to the in-coming call is the same as the limited telephone number stored in the memory when the receiving module receives the telephone number corresponding to the in-coming call but without responding an in-coming call signal corresponding to the in-coming call till the in-coming call signal of the in-coming call is over;
a limiting module limiting a back call from being sent to the limited telephone number corresponding to the in-coming call if a comparison result by the comparison module is true ; and
a back calling interface calling back to the telephone number corresponding to the in-coming call without the limited telephone number if the comparison result by the comparison module is not true.

2. The wireless communication device as recited in claim 1, further comprising a description module displaying a reason why the telephone number corresponding to the in-coming call is limited to be called back when the telephone number corresponding to the in-coming call is the same as the limited telephone number recorded in the memory.

3. The wireless communication device as recited in claim 1, further comprising an unreceived calls displaying module displaying the telephone number of the in-coming call when the in-coming call is not responded by a communication interface till the in-coming call signal is over.

4. The wireless communication device as recited in claim 1, further comprising a data adding module used to add, delete or change a limited telephone number in the memory.

5. The wireless communication device as recited in claim 4, wherein the data adding module comprises a inputting key used to input the limited telephone number to the memory.
